(19) United States
(12) Patent Application Publication
(10) Pub. No.: US 2008/0130684 A1
(43) Pub. Date: Jun. 5, 2008

(54) Method and apparatus for performing reordering in a wireless communications system

(76) Inventor: Sam Shiaw-Shiang Jiang, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(21) Appl. No.: 11/987,878

(22) Filed: Dec. 5, 2007

Related U.S. Application Data
(60) Provisional application No. 60/872,799, filed on Dec. 5, 2006.

(51) Int. Cl. H04L 29/06

(52) U.S. Cl. 370/476

(57) ABSTRACT

A reordering method for a receiver in a wireless communications system includes performing a function of header decompression by a Packet Data Convergence Protocol (PDCP) layer of the receiver, performing a function of Automatic Repeat Request or a function of service data unit reassembly by a Radio Link Control (RLC) layer of the receiver, and performing a function of packet reordering by the PDCP layer, and not performing the function of packet reordering by the RLC layer.

### CROSS REFERENCE TO RELATED APPLICATIONS

This application claims the benefit of U.S. Provisional Application No. 60/872,799, filed on Dec. 5, 2006 and entitled “Reordering scheme in LTE”, the contents of which are incorporated herein by reference.

### BACKGROUND OF THE INVENTION

1. Field of the Invention

The present invention relates to a method and apparatus for performing reordering in a wireless communications system, and more particularly, to a method and apparatus for accurately performing reordering, so as to prevent packet loss, decrease system complexity, enhance transmission efficiency, and save system resources.

2. Description of the Prior Art

The third generation mobile telecommunications system (called 3G system) provides high frequency spectrum utilization, universal coverage, and high quality, high-speed multimedia data transmission, and also meets all kinds of QoS requirements simultaneously, providing diverse, flexible, two-way transmission services and better communication quality to reduce transmission interruption rates. However, due to demand for high-speed and multimedia applications, the next generation mobile telecommunications technology and related communication protocols have been developed.

Long Term Evolution wireless communications system (LTE system), an advanced high-speed wireless communications system established upon the 3G mobile telecommunications system, supports only packet-switched transmission, and tends to implement both Medium Access Control (MAC) layer and Radio Link Control (RLC) layer in one single communication site, such as in Node B alone rather than in Node B and RNC (Radio Network Controller) respectively, so that the system structure becomes simple.

Take an LTE-related specification established by the 3GPP for example, the main functions of an RLC (Radio Link Control) layer include in-sequence delivery of upper layer PDUs (Protocol Data Units) except at HO (Handover) in the uplink, and the main functions of a PDCP (Packet Data Convergence Protocol) layer include in-sequence delivery of upper layer PDUs at HO in the uplink. “In-sequence delivery” means that packets are delivered in the order of generating the packets, and the order of generating the packets is determined according to sequence numbers) (SNs) of the packets. In other words, the RLC layer should perform reordering to recovery the order of the packets, so as to deliver PDUs in sequence. In such a situation, there may be two possible implementations: (1) the RLC layer performs reordering while the PDCP layer does not; or, (2) Both the PDCP and RLC layers perform reordering.

If both the PDCP and RLC layers perform reordering, the system complexity increases, and RLC reordering induces extra transmission delay and needs more buffer sizes. However, if the RLC layer performs reordering while the PDCP layer does not perform reordering, unnecessary packet loss may happen.

In the LTE network side, the RLC entity is located on eNB (enhanced Node B), while the PDCP entity can be located on eNB or on aGW (advance gateway or access gateway). No matter which site the PDCP entity is located on, after HO from a source eNB to a target eNB, PDUs with smaller SNs may not arrive the source eNB and need to be retransmitted to the target eNB due to packet loss. As a result, PDUs does not arrive the target eNB in the order of SNs.

Therefore, due to HO between the eNBs, RLC reordering does not guarantee that packets can arrive the PDCP entity in conformity with the order of PDCP SNs. In such a case, if the PDCP entity uses ROHC (Robust Header Compression) algorithm to de-/compress packet headers, and packets do not arrive the PDCP entity in the order of PDCP SNs, then header decompressing may fail leading to packet loss.

In short, in the prior art LTE system, due to the prerequisite assumption that the RLC layer performs reordering (in-sequence delivery to PDCP layer), if the PDCP layer also performs reordering, the system complexity increases, and transmission efficiency decreases. Otherwise, if the RLC layer performs reordering while the PDCP layer does not, unnecessary packet loss may happen due to header decompression failure.

### SUMMARY OF THE INVENTION

According to the present invention, a reordering method for a receiver in a wireless communications system comprises performing a function of header decompression by a Packet Data Convergence Protocol, called PDCP hereinafter, layer of the receiver, performing a function of Automatic Repeat Request or a function of service data unit reassembly by a Radio Link Control, called RLC hereinafter, layer of the receiver, and performing a function of packet reordering by the PDCP layer, and not performing the function of packet reordering by the RLC layer.

According to the present invention, a communications device for accurately performing reordering in a wireless communications system comprises a control circuit for realizing functions of the communications device, a processor installed in the control circuit, for executing a program code to command the control circuit, and a memory installed in the control circuit and coupled to the processor for storing the program code. The program code comprises performing a function of header decompression by a Packet Data Convergence Protocol, called PDCP hereinafter, entity of the receiver, performing a function of Automatic Repeat Request or a function of service data unit reassembly by a Radio Link Control, called RLC hereinafter, entity of the receiver, and performing a function of packet reordering by the PDCP entity, and not performing the function of packet reordering by the RLC entity.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a function block diagram of a wireless communications device.

FIG. 2 is a diagram of program code of FIG. 1.

FIG. 3 is a flowchart of a process according to an embodiment of the present invention.

### DETAILED DESCRIPTION

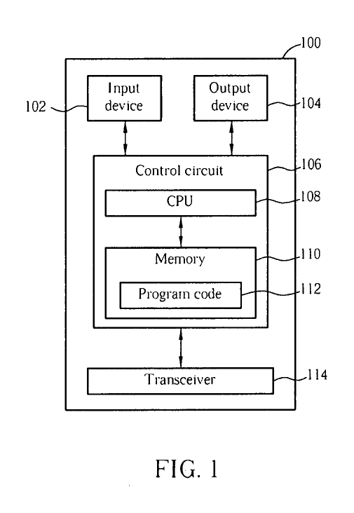

Please refer to FIG. 1, which is a functional block diagram of a communications device 100 in a wireless communications system. The wireless communications system is preferably the LTE system. For the sake of brevity, FIG. 1 only shows an input device 102, an output device 104, a control circuit 106, a central processing unit (CPU) 108, a memory 110, a program code 112, and a transceiver 114 of the communications device 100. In the communications device 100, the control circuit 106 executes the program code 112 in the memory 110 through the CPU 108, thereby controlling an operation of the communications device 100. The communications device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communications protocol framework, the transceiver 114 can be seen as a portion of Layer 1, and the control circuit 106 can be utilized to realize functions of Layer 2 and Layer 3.

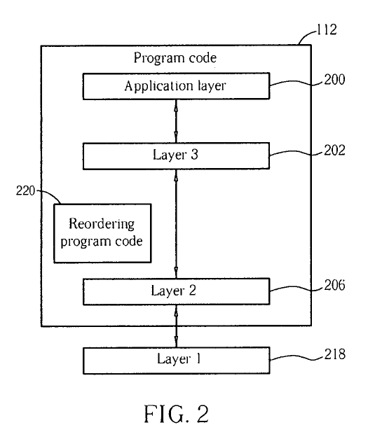

Please continue to refer to FIG. 2. FIG. 2 is a diagram of the program code 112 shown in FIG. 1. The program code 112 includes an application layer 200, a Layer 3 202, and a Layer 2 206, and is coupled to a Layer 1 218. The Layer 3 202 comprises a Radio Resource Control layer and a PDCP layer, and performs resource control. The Layer 2 206 comprises an RLC layer and a MAC layer, and performs link control. The Layer 1 218 performs physical connections.

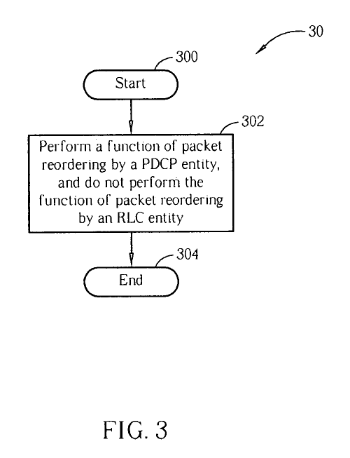

In order to recover packet data, the program code 112 can perform reordering, so as to process packets in sequence. In such a situation, the embodiment of the present invention provides a reordering program code 220, for accurately performing reordering. Please refer to FIG. 3, which illustrates a schematic diagram of a process 30. The process 30 is used for performing reordering in a wireless communications system, and can be compiled into the reordering program code 220. Note that, as in the prior art, a PDCP entity performs header compression in a transmitting side and header decompression in a receiving side. Besides, an AM (Acknowledged Mode) RLC entity performs Automatic Repeat Request (ARQ) function and an UM (Unacknowledged Mode) RLC entity performs service data unit (SDU) reassembly function. The process 30 comprises the following steps:
Step 300: Start.
Step 302: Perform a function of packet reordering by a PDCP entity, and do not perform the function of packet reordering by an RLC entity.
Step 304: End.

According to the process 30, in the embodiment of the present invention, the PDCP entity performs reordering, while the RLC entity does not perform reordering. Therefore, the embodiment of the present invention does not perform duplicate reordering, so as to decrease waste of system resources, and prevent packet loss due to header decompression failure.

In the embodiment of the present invention, the PDCP entity preferably de-/compresses packet headers by ROHC algorithm, and performs reordering according to PDCP SNs. Preferably, the RLC entity maintains a receiving window operation for avoiding delivering duplicate transmitted packets to the upper layer, or for the ARQ function. Besides, the communications device 100 can be operated in AM or UM.

Therefore, via the embodiment of the present invention, the RLC entity does not perform reordering, while the PDCP entity performs. In such a situation, even if the order of packets received by a receiver is different from the order of generating the packets due to HO between eNBs, the embodiment of the present invention can prevent unnecessary packet discard. Take uplink transmission for example (the network is receiver and the user equipment is transmitter), after HO between eNBs, if a packet with larger RLC SN and layer PDCP SN, which are set by the user equipment, arrives the target eNB earlier than a packet with smaller RLC SN and smaller PDCP SN, the PDCP entity will perform reordering according to PDCP SNs in the embodiment of the present invention, so as to recover the order of packets, and process the packets in sequence. Since the RLC entity does not perform reordering, system complexity decreases, so as to enhance transmission efficiency, and save system resources.

In summary, in the embodiment of the present invention, the PDCP entity performs reordering, while the RLC entity does not. Therefore, the embodiment of the present invention can prevent packet loss, decrease system complexity, enhance transmission efficiency, and save system resources.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A reordering method for a receiver in a wireless communications system comprising:
performing a function of header decompression by a Packet Data Convergence Protocol, called PDCP hereinafter, layer of the receiver;
performing a function of Automatic Repeat Request or a function of service data unit reassembly by a Radio Link Control, called RLC hereinafter, layer of the receiver; and
performing a function of packet reordering by the PDCP layer, and not performing the function of packet reordering by the RLC layer.

2. The reordering method of claim 1, wherein the PDCP layer performs the function of packet reordering according to PDCP sequences numbers of received packets.

3. The reordering method of claim 1, wherein the RLC layer is operated in an acknowledged mode.

4. The reordering method of claim 3 further comprising maintaining a receiving window operation by the RLC layer.

5. The reordering method of claim 4, wherein the receiving window operation is used for avoiding delivering duplicate transmitted packets to an upper layer.

6. The reordering method of claim 1, wherein the wireless communications system is operated in an unacknowledged mode.

7. A communications device for accurately performing reordering in a wireless communications system comprising:
a control circuit for realizing functions of the communications device;
a processor installed in the control circuit, for executing a program code to command the control circuit; and
a memory installed in the control circuit and coupled to the processor for storing the program code;
wherein the program code comprises:
performing a function of header decompression by a Packet Data Convergence Protocol, called PDCP hereinafter, entity of the receiver;
performing a function of Automatic Repeat Request or a function of service data unit reassembly by a Radio Link Control, called RLC hereinafter, entity of the receiver; and
performing a function of packet reordering by the PDCP entity, and not performing the function of packet reordering by the RLC entity.

8. The communications device of claim 7, wherein the PDCP entity performs the function of packet reordering according to PDCP sequences numbers of received packets.

9. The communications device of claim 7 operated in an acknowledged mode.

10. The communications device of claim 9, wherein the program code further comprises means of maintaining a receiving window operation by the RLC entity.

11. The communications device of claim 10, wherein the receiving window operation is used for avoiding delivering duplicate transmitted packets to an upper layer.

12. The communications device of claim 7 operated in an unacknowledged mode.
